(19) United States
(12) Patent Application Publication
(10) Pub. No.: US 2026/0036269 A1
(43) Pub. Date: Feb. 5, 2026

(54) PLANT-GROWING LIGHTING DEVICE

(71) Applicant: ODYSSEYGLOBAL CO., LTD., Gwangju (KR)

(72) Inventor: Jong Hyun JUNG, Gwangju (KR)

(73) Assignee: ODYSSEYGLOBAL CO., LTD., Gwangju (KR)

(21) Appl. No.: 19/159,067

(22) PCT Filed: Feb. 3, 2023
(86) PCT No.: PCT/KR2023/001572

§ 371 Date: Sep. 18, 2025

(30) Foreign Application Priority Data
Feb. 4, 2022 (KR) 10-2022-0014670
Dec. 19, 2022 (KR) 10-2022-0178294

(51) Int. Cl. F21S 4/28; A01G 7/04; F21V 23/00; F21V 29/70; F21Y 103/10; F21Y 113/10; F21Y 115/10

(52) U.S. Cl. CPC F21S 4/28; A01G 7/045; F21V 23/002; F21V 29/70; F21Y 2103/10; F21Y 2113/10; F21Y 2115/10

(57) ABSTRACT

Provided is a lighting device including a substrate, a plurality of first LEDs mounted on the substrate, installed in a line to be spaced apart from each other by a predetermined distance along a longitudinal direction of the substrate, and serially connected to each other to be simultaneously turned on/off, a plurality of second LEDs disposed between the first LEDs on a line on which the first LEDs are arranged, and serially connected to each other to be simultaneously turned on/off, and a plurality of third LEDs disposed to be located between the first LED and the second LED on the line where the first LEDs are arranged, and serially connected to each other to be simultaneously turned on/off. The plurality of the first LEDs, the second LEDs, and the third LEDs that are continuously disposed adjacent to each other may form one unit lighting unit.

### TECHNICAL FIELD

The present invention relates to a lighting device for plant growth, and more particularly, to a lighting device provided with a unit lighting unit including a plurality of first LEDs, second LEDs, and third LEDs that are continuously disposed adjacent to each other, in which the first LEDs, the second LEDs, and the third LEDs each output light of different wavelength bands to output light required for plant growth stages.

### BACKGROUND

In general, sunlight or artificial lighting such as incandescent lamps and high-pressure sodium lamps have been used for lighting required for crop growth, but in recent years, the use of semiconductor light emitting diodes for plant cultivation has brought significant economic effects to crop cultivation.

Recently, plant growth fostering devices using light emitting diodes (LEDs) for plant cultivation have been disclosed, and similar prior technologies have been developed in which one or two or more types of LEDs among various types of LEDs outputting optimal wavelength light corresponding to the types and growth processes of plants are disposed on a board in an appropriate ratio so as to be replaceable according to the types and growth status of crops.

Furthermore, for cultivating pigment plants, as a closed-type LED plant factory to enable high production efficiency and short-term cultivation in a small space, there has been disclosed a plant cultivation system constructed using wavelengths of 730 nm, 660 nm, and 450 nm.

In practice, three LED lightings with different wavelengths are purchased and the LED lightings are replaced and used according to the growth cycle of crops in a plant factory. In addition, five LED lightings with different wavelengths are periodically replaced and used.

However, conventional LED lighting devices control a plurality of LEDs with a single switching device, which makes it difficult for an operator to quickly respond to more diverse situations, and there is an economic burden of purchasing and installing multiple types of LED lighting devices, particularly in Korea where all LEDs must be imported, thereby hindering commercialization of smart farms, which are a core of the fourth industrial revolution.

Therefore, the following prior arts related to lighting devices for plant growth has been proposed.

The proposed prior art of a plant forced cultivation method and device using an LED lamp (Korean Patent No. 10-0902071) provides a forced cultivation method and device that can maximally promote the growth of cultivated plants through a means that properly controls a mixing ratio of red LED lamps and blue LED lamps, controls a light quantity ratio of irradiated light, and repeats on-time and off-time within a certain speed range, by using a rapid on/off characteristic and a monochromatic light emission characteristic of an LED lamp, and specifically, provides a plant forced cultivation method and device using an LED lamp in which red LEDs of 660 nm wavelength and blue LEDs of 450 nm wavelength are mixed in a ratio of 5:1 so that a light quantity ratio between red LEDs and blue LEDs is controlled to 5:1 or 10:1, and the on/off-time ratio becomes 1:1 or 1:2 so that the on-time is controlled within 100 microseconds to 10 seconds.

However, conventional LED lighting devices have difficulty in enabling an operator to quickly respond to various growth environments such as development and growth of multiple plants by outputting suitable light. In addition, conventional technology makes it difficult for an operator to arbitrarily control the flowering and fruiting period of cultivated plants, making it impossible to adjust production timing of fruits, thereby limiting productivity.

### DISCLOSURE

### Technical Problem

The present invention was devised to solve the above-mentioned problems of the prior art, and is directed to providing first LEDs, second LEDs, and third LEDs that each output light of different wavelength bands so that an operator can appropriately respond to various growth environments such as development and growth of plants without being affected by surrounding environments and artificially induce flowering and fruit period of cultivated plants.

### Technical Solution

A lighting device for plant growth according to the present invention to achieve the above objects may include a substrate extending in a predetermined length, a plurality of first LEDs mounted on the substrate, installed in a line to be spaced apart from each other by a predetermined distance along a longitudinal direction of the substrate, and serially connected to each other to be simultaneously turned on/off, a plurality of second LEDs disposed between the first LEDs on a line on which the first LEDs are arranged, and serially connected to each other to be simultaneously turned on/off, and a plurality of third LEDs disposed to be located between the first LED and the second LED on the line where the first LEDs are arranged, and serially connected to each other to be simultaneously turned on/off, wherein the plurality of the first LEDs, the second LEDs, and the third LEDs that are continuously disposed adjacent to each other may form one unit lighting unit, the unit lighting unit may be continuously disposed on the substrate, and the first LED, the second LED, and the third LED may each output light of different wavelength bands.

The lighting device for plant growth may further include a first circuit part, a second circuit part, and a third circuit part for supplying power to the first LED, the second LED, and the third LED, respectively, wherein the first circuit part may include a first circuit line extending along the longitudinal direction of the substrate at an upper end of the substrate, and a second circuit line spaced apart from the first circuit line by a predetermined distance, formed below the first circuit line, and having first protruding connection parts protruding downward by a predetermined length and disposed spaced apart along the longitudinal direction of the substrate, the second circuit part may include a third circuit line extending along the longitudinal direction of the substrate at a lower end of the substrate, and a fourth circuit line spaced apart from the third circuit line by a predetermined distance, formed at an upper portion of the third circuit line, and having second protruding connection parts protruding upward by a predetermined length so as not to overlap the second circuit line and disposed spaced apart along the longitudinal direction of the substrate, and the third circuit part may be located between the first circuit part and the second circuit part and includes a fifth circuit line and a sixth circuit line extending so as not to overlap the second circuit line and the fourth circuit line, wherein the first LED may be located at the first protruding connection part, the second LED may be located at the second protruding connection part, and the third LED may be located on an extension line extending along the sixth circuit line, and the first LED, the second LED, and the third LED may be disposed in a line along a virtual extension line extending along the longitudinal direction of the substrate.

Some of the first LEDs 130 included in the unit lighting unit 120 may output light of a preset first wavelength band, the remainder of the first LEDs 130 may output infrared light, the second LEDs 140 included in the unit lighting unit 120 may output light of a preset second wavelength band, some of the third LEDs 150 included in the unit lighting unit 120 may output light of a third wavelength band different from the first to the second wavelength bands, and the remainder of the third LEDs 150 may output ultraviolet light.

The unit lighting unit 120 may include the first LEDs outputting infrared light in a smaller number than that of the first LEDs outputting light of the first wavelength band, and include the third LEDs outputting ultraviolet light in a smaller number than that of the third LEDs outputting light of the third wavelength band.

The substrate may be provided with a cutting line between the unit lighting units adjacent to each other to independently use the unit lighting unit by cutting along the cutting line.

The unit lighting unit may emit central wavelengths of 380 nm, 450 nm, and 660 nm in the first wavelength band, emit central wavelengths of 450 nm, 660 nm, and 780 nm and a central wavelength band of 730 nm to 740 nm in the second wavelength band, and emit a central wavelength of 550 nm in the third wavelength band.

The lighting device for plant growth may further include a housing unit installed in an inner space of a plant cultivating device in which a plurality of plants are grown, the substrate being installed therein, and a cooling unit for supplying condensate water generated by condensing air in the inner space to the housing unit to cool the housing unit.

The cooling unit may further include a condensation plate installed above the housing unit, and
a cooling part for cooling the condensation plate so that the condensate water is generated on a surface of the condensation plate.

The housing unit may include a plurality of heat dissipation fins installed in an upper portion thereof to dissipate heat transferred to the substrate and a collecting part that is opposite to each other with respect to the heat dissipation fin, is formed in the upper portion of the housing unit, and is formed to be spaced apart from each other upward, and the condensation plate is formed to be convex downward toward the housing unit so that the condensate water falls onto the housing unit.

### Advantageous Effects

A lighting device for plant growth of the present invention is provided with a unit lighting unit including a first LED, a second LED, and a third LED that organically emit visible light and ultraviolet light in a specific region for promoting growth and development of cultivated plants, thereby having an advantage that light capable of controlling coloration of ornamental plants and selectively cultivating the fruiting period of plants for fruit production may be output, and also having an advantage that, according to a request of a user, the lighting can be switched to white lighting so that a growth state of crops may be accurately checked with the naked eye while enabling appropriate wavelength bands to be emitted according to the growth of the crops.

### DESCRIPTION OF DRAWINGS

FIG. 1 is a partial view showing a substrate according to one embodiment of a lighting device for plant growth of the present invention.

FIG. 2 is a partial view showing a first circuit part to a third circuit part of FIG. 1.

FIG. 3 is a Fraunhofer line graph showing a solar spectrum.

FIG. 4 is a partial conceptual diagram of FIG. 1.

FIG. 5 is a block diagram of FIG. 1.

FIG. 6 is an exemplary view of a plant cultivating device according to another embodiment of the lighting device for plant growth of the present invention.

FIG. 7 is a cross-sectional view showing a housing unit and a cooling unit of FIG. 4.

FIG. 8 is a partial perspective view showing the housing unit and the cooling unit of FIG. 4.

### MODES OF THE INVENTION

Hereinafter, a lighting device for plant growth according to embodiments of the present invention will be described in detail with reference to the accompanying drawings. Since the present invention may be variously modified and may have various forms, and specific embodiments are illustrated in the drawings and will be described in detail in the specification. However, it should be understood that this is not intended to limit the present invention to a specific disclosed form and includes all changes, equivalents, and substitutions included in the spirit and technical scope of the present invention. Like reference numerals have been used for like components throughout the description of each drawing. In the accompanying drawings, the dimensions of the structures are illustrated enlarged than the actual sizes for clarity of the present invention.

Terms such as first and second may be used to describe various components, but the components should not be limited by the terms. The terms are used only for the purpose of distinguishing one component from another. For example, a first component may be referred to as a second component, and similarly, the second component may also be referred to as the first component without departing from the scope of the present invention.

The terms used in the present application are only used to describe specific embodiments and are not intended to limit the present invention. The singular expression includes the plural expression unless the context clearly dictates otherwise. In the present application, it should be understood that terms such as “include” or “have” are intended to specify that features, numbers, steps, operations, components, parts, or combinations thereof described in the specification are present, but do not preclude the possibility of the presence or addition of one or more other features, numbers, steps, operations, components, parts, or combinations thereof.

Unless otherwise defined, all terms used herein including technical or scientific terms have the same meanings as those generally understood by those skilled in the art to which the present invention pertains. The terms defined in a generally used dictionary should be construed as meanings that match with the meanings of the terms from the context of the related technology and are not construed as an ideal or excessively formal meaning unless clearly defined in the present application.

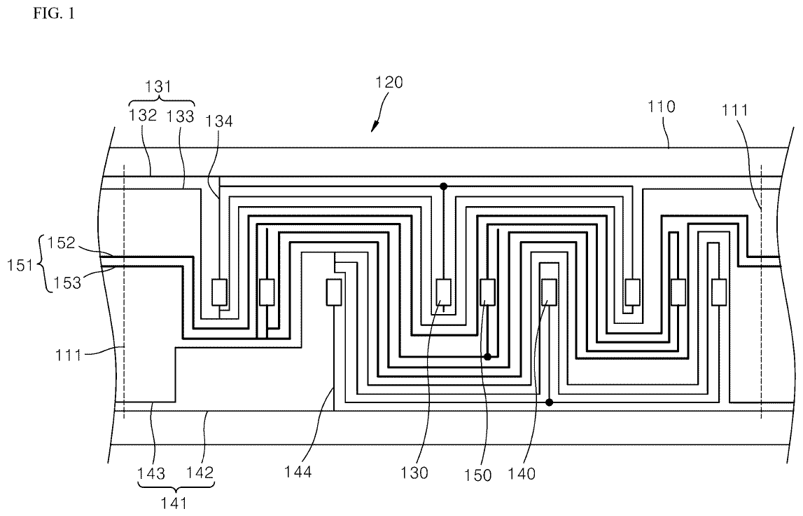

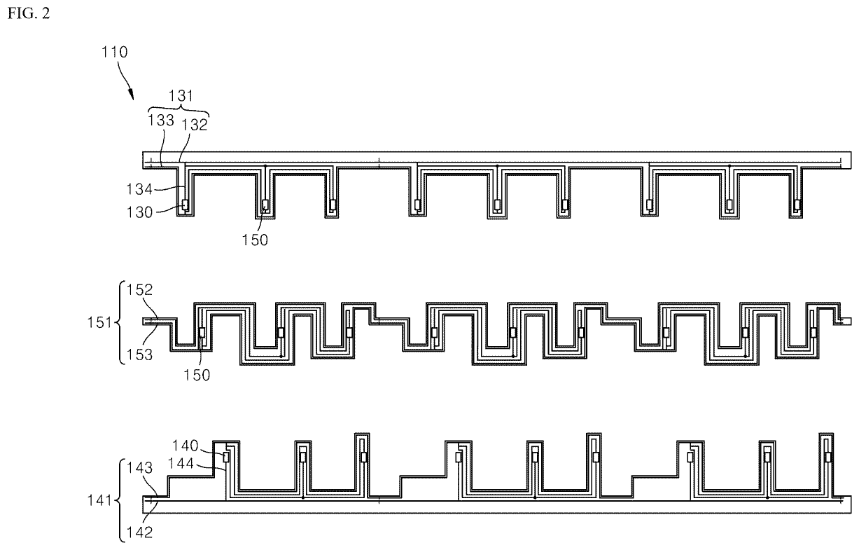

FIGS. 1 and 2 show one embodiment of a lighting device for plant growth 100 according to the present invention.

Referring to the drawings, the lighting device for plant growth 100 according to the present embodiment is provided with a substrate 110 and a unit lighting unit 120.

The substrate 110 is formed in a plate shape having a predetermined thickness and extends in a predetermined length along a front and rear direction. The substrate 110 is a PCB substrate that is conventionally and generally used to mount a light emitting diode such as an LED, and therefore, detailed description thereof will be omitted. The substrate 110 is installed in an inner space of a plant cultivating device 10 in which a plurality of plants are grown.

In addition, the substrate 110 is provided with a cutting line in a width direction of the substrate 110 so that the substrate 110 may be cut and used by an operator through a cutting means such as scissors or a knife to independently use the unit lighting unit 120 described below.

The unit lighting unit 120 is disposed on the substrate 110 and is provided with a plurality of first LEDs 130, second LEDs 140, and third LEDs 150 that output light of different wavelength bands, and the first LEDs 130, the second LEDs 140, and the third LEDs 150 each output light of different wavelength bands.

Therefore, some of the first LEDs 130 included in the unit lighting unit 120 output light of a preset first wavelength band, the remainder of the first LEDs 130 output infrared light, the second LEDs 140 included in the unit lighting unit 120 output light of a preset second wavelength band, some of the third LEDs 150 included in the unit lighting unit 120 output light of a third wavelength band different from the first to the second wavelength bands, and the remainder of the third LEDs 150 output ultraviolet light.

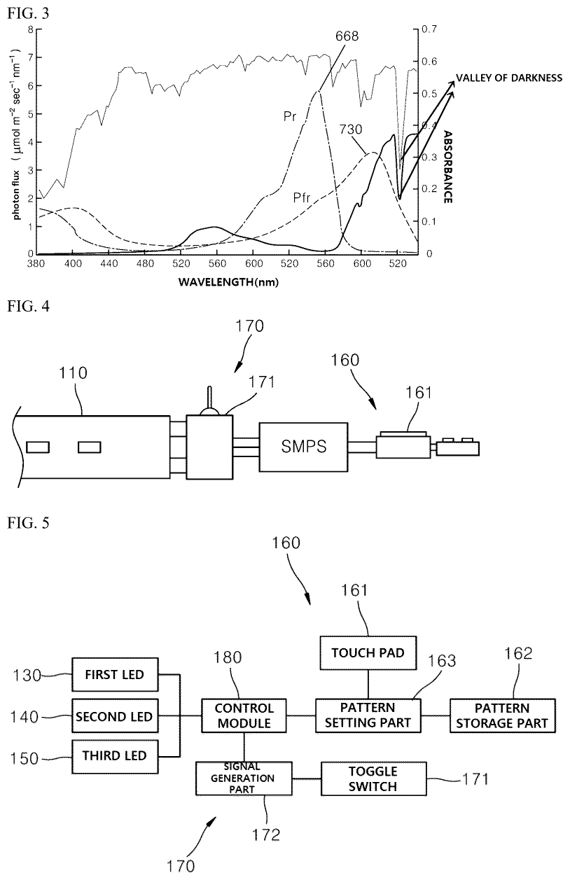

In this case, referring to FIG. 3 showing a solar system spectrum, it can be confirmed that photosynthetic photon flux in a wavelength band of 730 nm to 780 nm (a valley of darkness) sharply decreases in a near solid line (wavelength band of sunlight). And, referring to Pr (dash-dot line, graph of absorbance according to wavelength band of red light for plants) and Pfr (dotted line, graph of absorbance according to wavelength band of far-red light for plants), it can be confirmed that cultivated plants also have a low absorption rate in a region of the wavelength band of 730 nm to 780 nm.

And, the wavelength bands of the first to the third LEDs 130, 140, and 150 will be described in more detail as follows.

The first to the third wavelength bands may be installed to be output as follows in consideration of an influence on cultivated plants of the wavelength band of 730 nm to 780 nm (a valley of darkness of Fraunhofer curve) in a wavelength band representing the described solar system spectrum.

The first wavelength band is such that light having a central wavelength of 380 nm is emitted as 25% to 35% of a photosynthetic photon flux of the first LED 130, light having a wavelength band of 380 nm to 450 nm is emitted as 5% to 15% of the photosynthetic photon flux of the first LED 130, and light having a wavelength band of 600 nm to 700 nm is emitted as the remainder of the photosynthetic photon flux of the first LED 130, the second wavelength band is such that light having a central wavelength of 380 nm is emitted as 15% to 25% of a photosynthetic photon flux of the second LED 140, light having a wavelength band of 380 nm to 500 nm is emitted as 15% to 25% of the photosynthetic photon flux of the second LED 140, and light having a wavelength band of 600 nm to 800 nm is emitted as the remainder of the photosynthetic photon flux of the second LED 140, and the third wavelength band is such that light having a central wavelength band of 600 nm to 730 nm is emitted and light having a single peak wavelength of the 780 nm is emitted as 60% to 90% of a photosynthetic photon flux of the third LED 150.

In addition, the first wavelength band and the second wavelength band of the wavelength bands organically emit wavelength bands of specific regions that promote growth and development of cultivated plants.

The first wavelength band to the third wavelength band are not limited to the above-described wavelength bands and may be changed according to an applied plant. And, the unit lighting unit 120 includes the first LEDs outputting infrared light in a smaller number than that of the first LEDs outputting light of the first wavelength band, and includes the third LEDs outputting ultraviolet light in a smaller number than that of the third LEDs outputting light of the third wavelength band.

Meanwhile, in another embodiment of the unit lighting unit 120, an LED package in which a phosphor emitting green color or a chip emitting 450 nm is embedded is applied in any one LED among the first to the third LEDs 130, 140, and 150 so as to be recognized as white from the outside.

Therefore, the unit lighting unit 120 is disposed on the substrate 110 and is provided with a plurality of the first LEDs 130, the second LEDs 140, and the third LEDs 150 that output light of different wavelength bands, and the first LEDs 130, the second LEDs 140, and the third LEDs 150 each output light of different wavelength bands.

In this case, the wavelength bands of the first to the third LEDs 130, 140, and 150 of the present embodiment will be described in more detail as follows.

The first wavelength band is such that light having a wavelength of 660 nm is emitted as 30% to 50% of the photosynthetic photon flux of the first LED 130, light having a wavelength of 450 nm is emitted as 20% to 25% of the photosynthetic photon flux of the first LED 130, and light of a UV-a wavelength is emitted as the remainder of the photosynthetic photon flux of the first LED 130, the second wavelength band is such that light having a central wavelength of 700 nm is emitted as 10% to 15% of the photosynthetic photon flux of the second LED 140, light having a wavelength of 660 nm is emitted as 30% to 50% of the photosynthetic photon flux of the second LED 140, and light having a wavelength of 450 nm is emitted as the remainder of the photosynthetic photon flux of the second LED 140, and the third wavelength band is such that light having a central wavelength band of 600 nm to 730 nm is emitted and light having a single peak wavelength of the 780 nm is emitted as 60% to 90% of the photosynthetic photon flux of the third LED 150.

Meanwhile, in another embodiment of the unit lighting unit 120, a phosphor emitting green color is applied in any one LED among the first to the third LEDs 130, 140, and 150 so as to be recognized as white from the outside.

Therefore, the unit lighting unit 120 is disposed on the substrate 110 and is provided with a plurality of the first LEDs 130, the second LEDs 140, and the third LEDs 150 that output light of different wavelength bands, and the first LEDs 130, the second LEDs 140, and the third LEDs 150 each output light of different wavelength bands.

In this case, the wavelength bands of the first to the third LEDs 130, 140, and 150 of the present embodiment will be described in more detail as follows.

The first wavelength band emits central wavelengths of 380 nm, 450 nm, and 660 nm, the second wavelength band emits central wavelengths of 450 nm, 660 nm, and 780 nm and a central wavelength band of 730 nm to 740 nm, and the third wavelength band emits a central wavelength of 550 nm.

In addition, the wavelength bands of the first to the third LEDs 130, 140, and 150 of the present embodiment will be described in more detail as follows.

The first wavelength band is such that light having a central wavelength of 670 nm and a peripheral wavelength of 780 nm is emitted as 50% to 70% of the photosynthetic photon flux of the first LED 130, light having a central wavelength of 450 nm and a peripheral wavelength of 480 nm is emitted as 30% to 50% of the photosynthetic photon flux of the first LED 130, and light of a UV-a wavelength is emitted as the remainder of the photosynthetic photon flux of the first LED 130, the second wavelength band is such that light having a central wavelength band of 630 nm to 730 nm is emitted from the second LED 140, and light having a wavelength band of 740 nm to 770 nm is not emitted, and the third wavelength band is such that light having 3000 K to 6500 K is emitted so as to be recognized as white light by a user.

In this case, the first LEDs 130 are manufactured by a molding method in which the primary doping is performed for 10 seconds to 30 seconds at a preset first temperature, and then cooling treatment is performed for 1 minute to 5 minutes at a second temperature lower than the first temperature.

In addition, the lighting device for plant growth 100 according to the present invention further includes a first circuit part 131, a second circuit part 141, and a third circuit part 151 for supplying power to the first LEDs 130, the second LEDs 140, and the third LEDs 150, respectively.

The first circuit part 131 is installed in a line to be spaced apart from each other at a predetermined distance along a length direction of the substrate 110, serially connected to each other to be simultaneously turned on/off, and formed to supply power to the plurality of the first LEDs 130.

The first circuit part 131 includes a first circuit line 132 extending along the length direction of the substrate 110 from an upper end of the substrate 110, and a second circuit line 133 spaced apart from the first circuit line 132 by a predetermined distance, formed below the first circuit line 132, and having first protruding connection parts 134 that protrude downward by a predetermined length and are disposed spaced apart along the length direction of the substrate 110.

The second circuit part 141 is disposed between the first LEDs 130 on a line in which the first LEDs 130 are arranged, serially connected to each other to be simultaneously turned on/off, formed in plurality, and formed to supply power to the second LEDs 140.

The second circuit part 141 includes a third circuit line 142 extending along the length direction of the substrate 110 from a lower end of the substrate 110, and a fourth circuit line 143 spaced apart from the third circuit line 142 by a predetermined distance, formed at upper portion of the third circuit line 142, and having second protruding connection parts 144 that protrude upward by a predetermined length so as not to overlap the second circuit line 133 and are disposed spaced apart along the length direction of the substrate 110.

The third circuit part 151 is disposed to be located between the first LED 130 and the second LED 140 on a line in which the first LEDs 130 are arranged, serially connected to each other to be simultaneously turned on/off, formed in plurality, and formed to supply power to the third LED 150.

The third circuit part 151 is located between the first circuit part 131 and the second circuit part 141 and includes a fifth circuit line 152 and a sixth circuit line 153 extending so as not to overlap the second circuit line 133 and the fourth circuit line 143.

In this case, the first LED 130 is located at the first protruding connection part 134, the second LED 140 is located at the second protruding connection part 144, and the third LED 150 is located on an extension line extending along the sixth circuit line 153, and the first LED 130, the second LED 140, and the third LED 150 are disposed in a line along a virtual extension line extending along the length direction of the substrate 110.

The unit lighting unit 120 is operated by power supplied from a power supply unit. Here, since the power supply unit applies a power supply means that is conventionally and generally used to supply the power to the first circuit part 131, the second circuit part 141, and the third circuit part 151, detailed description thereof will be omitted.

The lighting device for plant growth 100 of the present embodiment described above has an advantage in that the plurality of the first LEDs 130, the second LEDs 140, and the third LEDs 150 that are continuously disposed adjacent to each other each output light of different wavelength bands and form one unit lighting unit 120, so light of various wavelength bands may be easily output, thereby enabling a rapid response to various situations according to the types or growth of the plants.

Meanwhile, although not shown in the drawings, the lighting device for plant growth 100 of the present invention may further include a measurement sensor installed on the substrate 110 to measure a concentration of oxygen or carbon dioxide in an inner space, a determination module to determine the growth state plants grown in the inner space based on information measured by the measurement sensor, and a recommendation module to provide an operator with information on a wavelength band of light corresponding to the growth state of the plants based on determination information provided by the determination module.

The measurement sensor is disposed on a lower surface of the substrate 110 opposite to the plants to measure a concentration of oxygen or carbon dioxide in the inner space of the plant cultivating device 10. The measurement sensor provides a measured concentration value to the determination module. The determination module calculates a rate of change in the concentration of oxygen or carbon dioxide in the inner space based on the information provided from the measurement sensor. There are differences in the change in the concentration of oxygen or carbon dioxide in the inner space depending on the growth of the plant, and the determination module determines the growth information of the plant based on the difference in the change in the concentration of oxygen or carbon dioxide.

In this case, the determination module may determine the growth degree of the plants by applying the calculated rate of change in the concentration to a neural network model that has been pre-constructed for determining the growth degree of the plants according to the rate of change in the concentration of oxygen or carbon dioxide in a space in which the plants are grown.

The recommendation module provides the operator with information on wavelength bands of light corresponding to the growth state of the plants according to the determination information provided from the determination module. The recommendation module includes a database in which information on a wavelength band of light suitable for each growth state of the plants is stored, extracts information on the wavelength bands of light corresponding to the growth state of the plants in the plant cultivating device 10 determined by the determination module from the database, and provides the information to the operator. In this case, the recommendation module may provide the recommendation information through a terminal such as a pre-registered smartphone of the operator.

Meanwhile, the lighting device for plant growth 100 according to the present embodiment further includes a first switch unit 160 for allowing the operator to input a first operation signal for operating of the unit lighting unit 120 by a touch operation, a second switch unit 170 for allowing the operator to input a second operation signal for operating of the unit lighting unit 120 by operating a toggle switch 171, and a control module 180 for controlling the unit lighting unit 120 according to the operation signals provided from the first and second switch units 160 and 170.

The first switch unit 160 allows the operator to input the first operation signal for operating of the unit lighting unit 120 by the touch operation, and includes an on-off power touch pad 161, a pattern storage part 162, and a pattern setting part 163.

The on-off power touch pad 161 is operable by the touch operation of the operator, and is provided at a position adjacent to the unit lighting unit 120. Since the on-off power touch pad 161 is a recognition means such as a touchscreen that is conventionally and generally used to recognize a finger touch of the operator, detailed description thereof will be omitted.

The pattern storage part 162 stores a plurality of light emission patterns for the operation of the first to the third LEDs 130, 140, and 150 of the unit lighting unit 120. The emission patterns include a light emission pattern in which only the first LED 130 operates, a light emission pattern in which only the second LED 140 operates, a light emission pattern in which only the third LED 150 operates, a light emission pattern in which the first and the second LEDs 130 and 140 operate, a light emission pattern in which the first and the third LEDs 130 and 150 operate, a light emission pattern in which the second and the third LEDs 140 and 150 operate, and a light emission pattern in which the first to the third LEDs 130, 140, and 150 operate, and the like.

The pattern setting part 163 generates the first operation signal to operate the first to third LEDs 130, 140, and 150 of the unit lighting unit 120 by any one of the light emission patterns stored in the pattern storage part 162 and transmits the first operation signal to the control module 180. Here, when a touch of the operator is input to the on-off power touch pad 161, the pattern setting part 163 generates the first operation signal so that the light emission pattern applied to the first to the third LEDs 130, 140, and 150 among the light emission patterns is sequentially changed according to a preset operation order.

As an example, when the touch of the operator is first recognized on the on- off power touch pad 161, the pattern setting part 163 generates the first operation signal corresponding to the light emission pattern in which only the first LED 130 operates, and when the touch of the operator is recognized again on the on-off power touch pad 161, the pattern setting part 163 generates the first operation signal corresponding to the light emission pattern in which only the second LED 140 operates. In addition, when the touch of the operator is recognized again on the on-off power touch pad 161, the pattern setting part 163 generates the first operation signal corresponding to the light emission pattern in which only the third LED 150 operates, and when the touch of the operator is re-recognized on the on-off power touch pad 161, the pattern setting part 163 generates the first operation signal corresponding to the light emission pattern in which the first and the second LEDs 130 and 140 operate. And, when the touch of the operator is re-recognized on the on-off power touch pad 161, the pattern setting part 163 generates the first operation signal corresponding to the light emission pattern in which the first and the third LEDs 130 and 150 operate, and when the touch of the operator is recognized again on the on-off power touch pad 161, the pattern setting part 163 generates the first operation signal corresponding to the light emission pattern in which the second and the third LEDs 140 and 150 operate. In addition, when the touch of the operator is recognized again on the on-off power touch pad 161, the pattern setting part 163 generates the first operation signal corresponding to the light emission pattern in which the first to the third LEDs 130, 140, and 150 operate, and when the touch of the operator is re-recognized on the on-off power touch pad 161, the pattern setting part 163 generates the first operation signal corresponding to the light emission pattern in which the first LED 130 operates.

In this case, the operation order of the light emission patterns is not limited thereto, and it is preferable that the first to the third LEDs 130, 140, and 150 of wavelength bands suitable for the growth of plants are set by an expert, and that the first to the third LEDs 130, 140, and 150 are sequentially set according to the growth period of the plants. Therefore, even when the operator is not an expert, the unit lighting unit 120 may be operated so that light of wavelength bands corresponding to the growth state of the plants is irradiated by sequentially touching the on-off power touch pad 161.

The second switch unit 170 includes the toggle switch 171 and a signal generation part 172 that generates the second operation signal for the operation of the unit lighting unit 120 according to the operation of the toggle switch 171.

The toggle switch 171 is provided with a lever so that the operator may operate the toggle switch 171, and the lever is formed to be set at any one of a plurality of setting positions or a neutral position by the operation of the operator. Here, since the toggle switch 171 is a toggle switch that is conventionally and generally used to locate the lever at any one of an up, down, or neutral position, detailed description thereof will be omitted. In this case, a plurality of the toggle switches 171 may be provided according to the number of the first to the third LEDs 130, 140, and 150 of the unit lighting unit 120.

The signal generation part 172 generates the second operation signal so that the first to the third LEDs 130, 140, and 150 operate in different operation patterns according to a position of the lever set by the operator. Here, the operation patterns include an operation pattern in which only the first LED 130 operates, an operation pattern in which only the second LED 140 operates, an operation pattern in which only the third LED 150 operates, an operation pattern in which the first and the second LEDs 130 and 140 operate, an operation pattern in which the first and the third LEDs 130 and 150 operate, an operation pattern in which the second and the third LEDs 140 and 150 operate, and an operation pattern in which the first to the third LEDs 130, 140, and 150 operate, and the like.

As an example, when the lever is set to any one of the setting positions, the signal generation part 172 may generate the second operation signal corresponding to the operation pattern in which only the first LED 130 operates, and when the lever is set to another one of the setting positions, the signal generation part 172 may generate the second operation signal corresponding to the operation pattern in which only the third LED 150 operates. Here, the operation pattern may be set by the operator.

The control module 180 controls the unit lighting unit 120 according to the first operation signal or the second operation signal provided from the first and the second switch units 160 and 170. In this case, when the lever of the toggle switch 171 is set to the neutral position, the control module 180 controls the operation of the first to the third LEDs 130, 140, and 150 in response to the first operation signal provided from the first switch unit 160. In addition, when the lever of the toggle switch 171 is set to the setting positions, the control module 180 controls the operation of the first to the third LEDs 130, 140, and 150 in response to the second operation signal provided from the second switch unit 170.

That is, when the lever of the toggle switch 171 is set to the neutral position, the operator may sequentially change the light emission pattern of the unit lighting unit 120 by using the on-off power touch pad 161 according to a preset operation order, and when the lever of the toggle switch 171 is set to a setting position other than the neutral position, the control module 180 controls the unit lighting unit 120 so that the first to the third LEDs 130, 140, and 150 set to the setting position operate.

As described above, the operator may selectively control the unit lighting unit 120 through the on-off power touch pad 161 or the toggle switch 171, and when the unit lighting unit 120 is controlled by the on-off power touch pad 161, the first to the third LEDs 130, 140, and 150 are operated according to an operation order that is preset by an expert, so that even when the operator is not an expert, light of wavelength bands suitable for the growth state of plants may be irradiated to the plants, and when the unit lighting unit 120 is controlled through the toggle switch 171, an operation pattern of the first to the third LEDs 130, 140, and 150 may be changed more quickly than the control by the on-off power touch pad 161. Therefore, the lighting device for plant growth 100 according to the present invention has an advantage in that a plurality of LEDs may be easily operated according to a plurality of operation patterns by using the toggle switch 171 and the on-off power touch pad 161, thereby enabling a rapid response to various situations according to the types or growth of the plants.

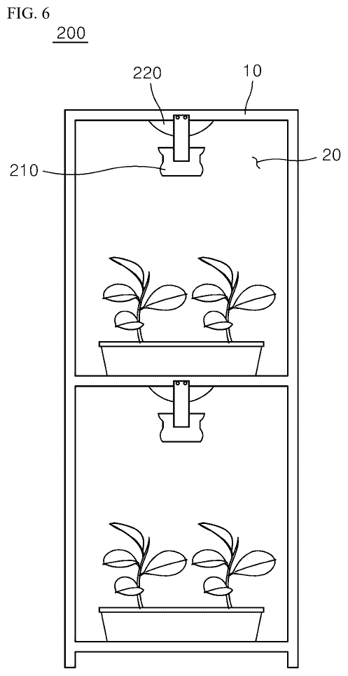

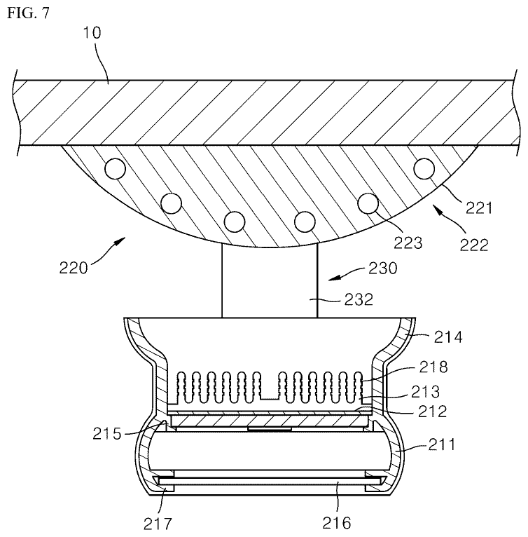

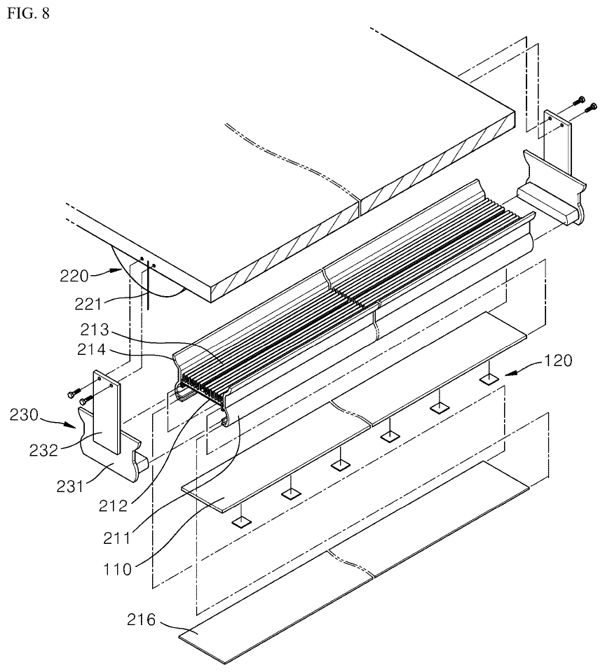

Meanwhile, FIGS. 6 to 8 show another embodiment of a lighting device for plant growth 200.

Elements having the same functions as those in the drawings shown above are denoted by the same reference numerals.

The lighting device for plant growth 200 according to the present invention includes a housing unit 210 installed in an inner space 20 of the plant cultivating device 10 in which a plurality of plants are grown, with the substrate 110 installed therein, and a cooling unit 220 for supplying condensate water generated by condensing air in the inner space 20 to the housing unit 210 to cool the housing unit 210.

The housing unit 210 is provided with a case 211, a heat dissipation plate 212, a heat dissipation fin 213, and a collecting part 214.

The case 211 is provided with a fitting groove 215 inside to accommodate the substrate 110 and formed in a cylindrical shape extending in a predetermined length along a length direction of the substrate 110, and a transparent plate 216 is installed on a lower surface corresponding to the substrate 110 to transmit light of the first to the third wavelength bands output from the unit lighting unit 120 and to prevent radiant heat generated from the substrate 110 from being transferred to the plants. In this case, a sliding groove 217 is formed at a lower end portion of the case 211 so that the transparent plate 216 may be slidingly coupled to the case 211.

The heat dissipation plate 212 is formed between the substrate 110 and the heat dissipation fins 213 described below and installed in the form of a plate made of aluminum material having high thermal conductivity so that heat generated from the substrate 110 may be thermally conducted to the heat dissipation fin 213, and a waterproof member (not shown) is formed to surround an outer surface of the case 211 so that condensate water may not permeate into the substrate 110.

The heat dissipation fin 213 is coupled to an upper surface of the heat dissipation plate 212 and formed with a plurality of protrusions protruding upward, and a protrusion groove 218 is provided in the protrusions so as to collect condensate water and increase heat dissipation efficiency of the condensate water.

The collecting part 214 is opposite to each other with respect to the heat dissipation fin 213, extends upward in an upper portion of the housing unit 210, and is formed so that an upper end portion thereof is formed to be spaced apart from each other upward, and an uppermost end portion of the collecting part 214 is formed to extend upward by a predetermined height higher than that of the heat dissipation fin 213 so that the condensate water may flow into the heat dissipation fin 213 by the collecting part 214.

The cooling unit 220 is provided with a condensation plate 221 and a cooling part 222.

The condensation plate 221 is spaced apart by a predetermined distance above the housing unit 210, connected to the plant cultivating device 10 at an upper end portion thereof, formed so that the condensate water is generated on a lower surface thereof, and formed to be convex downward toward the housing unit 210 so that the condensate water falls onto the housing unit 210.

In addition, although not shown in the drawings, a condensate water guide member protruding by a predetermined height from edges corresponding to each other of the condensation plate 221 toward a center of the condensation plate 221 is installed spaced apart by a predetermined distance in a forming direction of the condensation plate 221 so that the condensate water generated on the condensation plate 221 may fall onto the heat dissipation fin 213.

The cooling part 222 includes a plurality of cooling tubes 223 installed inside the condensation plate 221 so that condensate water may be generated on the condensation plate 221 and extending in a longitudinal direction of the condensation plate 221, and a cooling pump (not shown) for circulating a cooling medium inside the cooling tubes 223.

The cooling tube 223 may be aluminum tube having high thermal conductivity, and although various conventional tube shapes capable of thermal conduction may be applied, as shown in the drawings, a plurality of circular tubes are preferred.

The cooling pump may apply an air pump technology for circulating external air at a lower temperature than internal air so that the condensation plate 221 may cool the internal air below a dew point, and may also apply a thermoelectric element technology for cooling the condensation plate 221 by circulating cooling water cooled below the dew point in the cooling tube 223 using electric energy.

The lighting device for plant growth 200 according to the present invention further includes a fixing unit 230 formed so that the housing unit 210 may be installed below the cooling unit 220.

The fixing unit 230 includes an inserting member 231 formed at both end portions of the housing unit 210, with one end portion thereof being fitted into the case 211 and the other end portion thereof being coupled to both end portions of the housing unit 210 so that an inside of the housing unit 210 is airtight, and a fixing frame 232 in the form of a plate, which is connected at a lower portion thereof to the other end portion of the inserting member 231, bolt-coupled at an upper end thereof to the plant cultivating device 10 at an upper end of the cooling unit 220, and extended by a predetermined length in a vertical direction so that the cooling unit 220 and housing unit 210 may be spaced apart by a predetermined distance in the vertical direction.

The lighting device for plant growth 200 of the present embodiment described above is provided with the cooling unit 220 for supplying the condensate water generated by condensing air in the inner space 20 to the housing unit 210 to cool the housing unit 210, and therefore, there is an advantage that heat generated from the substrate 110 may be efficiently cooled.

The description of the suggested embodiments is provided so that those skilled in the art of the present invention may use or practice the present invention. Various modifications to these embodiments will be apparent to those skilled in the art of the present invention, and the general principles defined herein may be applied to other embodiments without departing from the scope of the present invention. Therefore, the present invention is not limited to the embodiments suggested herein, but should be construed in the widest scope consistent with the principles and novel features suggested herein.

1. A lighting device for plant growth, comprising:
a substrate extending in a predetermined length;
a plurality of first LEDs mounted on the substrate, installed in a line to be spaced apart from each other by a predetermined distance along a longitudinal direction of the substrate, and serially connected to each other to be simultaneously turned on/off;
a plurality of second LEDs disposed between the first LEDs on a line on which the first LEDs are arranged, and serially connected to each other to be simultaneously turned on/off; and
a plurality of third LEDs disposed to be located between the first LED and the second LED on the line where the first LEDs are arranged, and serially connected to each other to be simultaneously turned on/off;
wherein the plurality of the first LEDs, the second LEDs, and the third LEDs that are continuously disposed adjacent to each other form one unit lighting unit, the unit lighting unit is continuously disposed on the substrate, and the first LED, the second LED, and the third LED each output light of different wavelength bands.

2. The lighting device for plant growth of claim 1, further comprising
a first circuit part, a second circuit part, and a third circuit part for supplying power to the first LED, the second LED, and the third LED, respectively,
wherein the first circuit part includes a first circuit line extending along the longitudinal direction of the substrate at an upper end of the substrate, and a second circuit line spaced apart from the first circuit line by a predetermined distance, formed below the first circuit line, and having first protruding connection parts protruding downward by a predetermined length and disposed spaced apart along the longitudinal direction of the substrate,
the second circuit part includes a third circuit line extending along the longitudinal direction of the substrate at a lower end of the substrate, and a fourth circuit line spaced apart from the third circuit line by a predetermined distance, formed at an upper portion of the third circuit line, and having second protruding connection parts protruding upward by a predetermined length so as not to overlap the second circuit line and disposed spaced apart along the longitudinal direction of the substrate, and
the third circuit part is located between the first circuit part and the second circuit part and includes a fifth circuit line and a sixth circuit line extending so as not to overlap the second circuit line and the fourth circuit line,
wherein the first LED is located at the first protruding connection part, the second LED is located at the second protruding connection part, and the third LED is located on an extension line extending along the sixth circuit line, and the first LED, the second LED, and the third LED are disposed in a line along a virtual extension line extending along the longitudinal direction of the substrate.

3. The lighting device for plant growth of claim 1, wherein
some of the first LEDs included in the unit lighting unit output light of a preset first wavelength band and the remainder of the first LEDs output infrared light,
the second LED included in the unit lighting unit outputs light of a preset second wavelength band, and
some of the third LEDs included in the unit lighting unit output light of a third wavelength band different from the first to the second wavelength bands and the remainder of the third LEDs output ultraviolet light.

4. The lighting device for plant growth of claim 3, wherein
the unit lighting unit emits central wavelengths of 380 nm, 450 nm, and 660 nm in the first wavelength band, emits central wavelengths of 450 nm, 660 nm, and 780 nm and a central wavelength band of 730 nm to 740 nm in the second wavelength band, and emits a central wavelength of 550 nm in the third wavelength band.

5. The lighting device for plant growth of claim 3, wherein
the unit lighting unit includes the first LEDs outputting infrared light in a smaller number than that of the first LEDs outputting light of the first wavelength band, and
includes the third LEDs outputting ultraviolet light in a smaller number than that of the third LEDs outputting light of the third wavelength band.

6. The lighting device for plant growth of claim 5, wherein
the substrate is provided with a cutting line between the unit lighting units adjacent to each other to independently use the unit lighting unit by cutting along the cutting line.

7. The lighting device for plant growth of claim 6, further comprising:
a housing unit installed in an inner space of a plant cultivating device in which a plurality of plants are grown, the substrate being installed therein, and
a cooling unit for supplying condensate water generated by condensing air in the inner space to the housing unit to cool the housing unit.

8. The lighting device for plant growth of claim 7, wherein
the cooling unit further includes a condensation plate installed above the housing unit, and
a cooling part for cooling the condensation plate so that the condensate water is generated on a surface of the condensation plate.

9. The lighting device for plant growth of claim 8, wherein
the housing unit includes a plurality of heat dissipation fins installed in an upper portion thereof to dissipate heat transferred to the substrate and a collecting part that is opposite to each other with respect to the heat dissipation fin, is formed in the upper portion of the housing unit, and is formed to be spaced apart from each other upward, and
the condensation plate is formed to be convex downward toward the housing unit so that the condensate water falls onto the housing unit.
